(19) United States
(12) Patent Application Publication
(10) Pub. No.: US 2008/0025781 A1
(43) Pub. Date: Jan. 31, 2008

(54) Printer and method for controlling the printer

(75) Inventors: Kaoru Koyama, Shiojiri-shi (JP); Hitoshi Igarashi, Shiojiri-shi (JP); Takuya Yasue, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/880,697

(22) Filed: Jul. 24, 2007

(30) Foreign Application Priority Data
Jul. 25, 2006 (JP) 2006-201670

(51) Int. Cl. B41J 11/00

(52) U.S. Cl. 400/582

(57) ABSTRACT

A transporting roller operable to transport a printing medium fed from a medium setting portion on which the printing medium is set. A feeding roller is operable to feed the printing medium from the medium setting portion. A controller is operable to execute at least a synchronous transporting control of the printing medium in a first printing mode and execute at least a separate transporting control of the printing medium in a second printing mode when continuously printing on plural sheets of the printing medium. In the synchronous transporting control, the transporting roller and the feeding roller which rotate at the same circumferential speed transport the printing medium fed from the medium setting portion in cooperation with each other. In the separate transporting control, the feeding roller is stopped after feeding the printing medium from the medium setting portion and the transporting roller transports the printing medium fed from the medium setting portion while the feeding roller is stopped.

The disclosure of Japanese Patent Application No. 2006-201670 filed Jul. 25, 2006 including specification, drawings and claims is incorporated herein by reference in its entirety.

### BACKGROUND

The present invention relates to a printer and a method for controlling the printer.

As an ink jet printer in which printing is conducted on a predetermined printing medium such as printing paper, a related-art printer includes a paper feeding roller for feeding printing paper into the printer and a paper transporting roller for transporting printing paper at the time of conducting printing on printing paper fed into the printer (for example, refer to Japanese Patent Publication No. 2003-72964A and Japanese Patent Publication No. 2006-117385A).

In the printer described in the Japanese Patent Publication No. 2003-72964A, the paper feeding roller is connected to a paper transporting motor which drives the paper transporting roller, through a clutch. Therefore, the paper feeding roller can be disconnected from the paper transporting roller. In the printer described in the Japanese Patent Publication No. 2003-72964A, printing paper, which is set in a paper feeding hopper, is transported to a position of the paper transporting roller by the paper feeding roller connected to the paper transporting motor. When printing paper is transported to the position of the paper transporting roller, the paper feeding roller and the paper transporting roller are disconnected from each other. After that, printing paper is transported by the paper transporting roller.

In the printer described in the Japanese Patent Publication No. 2006-117385A, the paper feeding roller and the paper transporting roller are respectively driven by different motors. That is, the paper feeding roller is driven by a paper feeding motor. The paper transporting roller is driven by a paper transporting motor. In the same manner as that of the printer described in the Japanese Patent Publication No. 2003-72964A, in the printer described in the Japanese Patent Publication No. 2006-117385A, printing paper is transported to a position of the paper transporting roller by the paper feeding roller. After that, printing paper is transported by the paper transporting roller.

Recently, in the market of printers, it is demanded to enhance through-put (the number of sheets of printing paper processed in a unit time) at the time of continuous printing in which printing is conducted on a plurality of sheets of printing paper. However, in the printers described in the Japanese Patent Publication No. 2003-72964A and the Japanese Patent Publication No. 2006-117385A, sheets of printing paper are fed by the paper feeding roller to a position of the paper transporting roller and then transported by the paper transporting roller. That is, the printing action or the paper transporting action is different from the paper feeding action. Therefore, it is difficult to enhance throughput of the printers described in the Japanese Patent Publication No. 2003-72964A and the Japanese Patent Publication No. 2006-117385A.

### SUMMARY

It is therefore an object of the present invention to provide a printer having a constitution capable of enhancing throughput. It is another object of the present invention to provide a method of controlling a printer by which throughput can be more enhanced.

In order to achieve the above objects, according to an aspect of the present invention there is provided a printer operable to print on a printing medium, comprising:

a transporting roller operable to transport the printing medium fed from a medium setting portion on which the printing medium is set;

a feeding roller operable to feed the printing medium from the medium setting portion; and

a controller operable to execute at least a synchronous transporting control of the printing medium in a first printing mode and execute at least a separate transporting control of the printing medium in a second printing mode when continuously printing on plural sheets of the printing medium, wherein:

in the synchronous transporting control, the transporting roller and the feeding roller which rotate at the same circumferential speed transport the printing medium fed from the medium setting portion in cooperation with each other; and

in the separate transporting control, the feeding roller is stopped after feeding the printing medium from the medium setting portion and the transporting roller transports the printing medium fed from the medium setting portion while the feeding roller is stopped.

The printer of the present invention includes the feeding roller, which is rotated at the same circumferential speed as that of the transporting roller, capable of transporting a printing medium, which is fed from a medium setting portion, in cooperation with a transporting roller. In the first printing mode, synchronous transporting control is conducted by transporting roller and the feeding roller, which are rotated at the same circumferential speed, so that the printing medium fed from a medium setting portion can be transported. That is, in the first printing mode, while the feeding roller and the transporting roller are being synchronously driven, the printing medium fed from a medium setting portion is transported. Therefore, the printing medium can be fed without causing any problems in the transporting action and the printing action of the printing medium. That is, the printing action, the transporting action and the feeding action can be performed as a series of actions. As a result, at the time of continuous printing, throughput can be more enhanced. In the first printing mode, while the feeding roller and the transporting roller are being synchronized with each other, the printing medium fed from the medium setting portion can be transported. Accordingly, even between the feeding roller and the transporting roller, the printing medium can be appropriately transported. As a result, an intensity of noise can be suppressed which is generated by a change in tension given to the printing medium at the time of transporting. That is, an intensity of noise can be suppressed which is generated when the printing medium is loosened and stretched by a change in tension given to the printing medium at the time of transporting.

In the printer of the present invention, in the second printing mode, the separate transporting control is conducted, in which the printing medium fed from the medium setting portion is transported by the transporting roller under the condition that the feeding roller is stopped after the printing medium has been fed from the medium setting portion. Therefore, in the second printing mode, the transporting action and the printing action of the printing medium can be conducted differently from the feeding action of the printing medium. Accordingly, the printing action can be performed without being affected by the feeding action. For example, it is possible to conduct a so-called “cue of the printing medium” in which a position of a leading end of the printing medium is made to coincide with the printing head to conduct printing. Further, it is possible to set a transporting amount of the printing medium irrespective of the feeding action. As a result, the printing precision can be enhanced.

The controller may execute the separate transporting control on the last one of the plural sheets of the printing medium in the first printing mode. With this configuration, even in a case where plural sheets of the printing medium, the number of which is not less than a preset number of sheets in the continuous printing, are set in the medium setting portion in which printing mediums are set before conducting printing, it is possible to positively prevent a following printing medium from being fed from the medium setting portion.

According another aspect of the invention, there is provided a method for controlling a printer operable to print on a printing medium, comprising:

judging whether the recording medium is printed in a first printing control in which at least a synchronous transporting control of the printing medium is executed or in a second printing control in which at least a separate transporting control of the printing medium is executed when continuously printing on plural sheets of the printing medium;

when it is judged that the recording medium is printed in the first printing control, transporting the printing medium and printing on the printing medium in the first printing control; and

when it is judged that the recording medium is printed in the second printing control, transporting the printing medium and printing on the printing medium in the second printing control, wherein:

in the synchronous transporting control, a transporting roller operable to transport the printing medium fed from a medium setting portion on which the printing medium is set and a feeding roller operable to feed the printing medium from the medium setting portion, which rotate at the same circumferential speed transport the printing medium fed from the medium setting portion in cooperation with each other; and

in the separate transporting control, the feeding roller is stopped after feeding the printing medium from the medium setting portion and the transporting roller transports the printing medium fed from the medium setting portion while the feeding roller is stopped.

According to the method of controlling a printer of the present invention, when it is judged in the judging that printing is conducted in the first printing mode, synchronous transporting control is performed in which the transporting roller and the feeding roller, which are rotated at the substantially same circumferential speed, are made to cooperate with each other and the printing medium fed from the medium setting portion is transported by the rollers. That is, in a case where the printing is conducted in the first printing mode, while the feeding roller and the transporting roller are being synchronized with each other, the printing medium fed from the medium setting portion is transported. Therefore, the printing medium can be fed without causing any problem in the transporting action and the printing action of the printing medium. As a result, throughput can be more enhanced at the time of the continuous printing. In a case where printing is conducted in the first printing mode, while the feeding roller and the transporting roller are being synchronized with each other, the printing medium fed from the medium setting portion can be transported. Therefore, even between the feeding roller and the transporting roller, it is possible to appropriately transport the printing medium. As a result, the generation of noise can be suppressed which is generated at the time of transporting from the printing medium when tension given to the printing medium is changed.

According to the method of controlling a printer of the present invention, when it is judged in the judgment step that printing is conducted in the second printing mode, separate transporting control is performed in which a printing medium fed from the medium setting portion is transported by the transporting roller under the condition that the feeding roller is stopped after the printing medium has been fed from the medium setting portion. In the second printing mode, the transporting action and the printing action of the printing medium can be conducted differently from the feeding action of the printing medium. Accordingly, the printing action and others can be performed without being affected by the feeding action. As a result, the printing precision can be enhanced.

According to a further aspect of the invention, there is also provided a method for controlling a printer operable to print on a printing medium;

rotating a feeding roller at a first circumferential speed, thereby feeding a first printing medium;

rotating a transporting roller at the first circumferential speed, thereby transporting the fed first printing medium in cooperation with the feeding roller; and

printing on the transported first printing medium.

The method may further comprise rotating a ejecting roller at the first circumferential speed, thereby ejecting the printed first printing medium in cooperation with the transporting roller.

The transporting roller may start to rotate at a time when the feeding roller starts to rotate.

The transporting roller may start to rotate at a time when a predetermined time period is elapsed after the feeding roller starts to rotate.

The method may further comprise:

rotating the feeding roller, thereby feeding a second printing medium toward the transporting roller;

stopping the feeding roller after the fed second printing medium comes in contact with the transporting roller;

rotating the transporting roller, thereby transporting the fed second printing medium; and

printing on the transported second printing medium.

The method may further comprise:

separating the feeding roller from the second printing medium after stopping the feeding roller.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a side view showing an outline of the structure of a primary portion of a printer of an embodiment of the present invention;

FIG. 2 is a schematic illustration schematically showing an outline of the structure of a drive portion such as PF drive roller and others shown in FIG. 1;

FIGS. 3(A) and (B) are views for explaining actions of a rear paper feeding hopper and a retard roller shown in FIG. 1;

FIG. 4 is a block diagram showing an outline of the structure of a control portion and its peripheral devices shown in FIG. 2;

FIG. 5 is a block diagram schematically showing a portion of the inner structure of DC unit shown in FIG. 4;

FIGS. 6(A), 6(B) and 6(C) are schematic illustrations for explaining a method of transporting control of printing paper at the time of continuous printing in the normal printing mode;

FIG. 7 is a table in which an example of the target speed stored in ROM of FIG. 4 is schematically shown;

FIG. 8 is a graph showing a speed profile of PF drive roller and a rear paper feeding roller made according to the target speed table shown in FIG. 7;

FIG. 9 is a graph showing a relation between the rotating speed of each roller and the time when one sheet of printing paper P is transported by both PF drive roller and the rear paper feeding roller;

FIGS. 10(A), 10(B), 10(C) and 10(D) are schematic illustrations for explaining a control method when the first sheet of printing paper P is transported at the time of continuous printing in the draft printing mode;

FIGS. 11(A), 11(B) and 11(C) are schematic illustrations for explaining a control method when two continuous sheets of printing paper P are transported at the time of continuous printing in the draft printing mode;

FIGS. 12(A) and 12(B) are schematic illustrations for explaining a control method when the last sheet of printing paper P is transported at the time of continuous printing in the draft printing mode;

FIG. 13 is a flow chart showing a procedure of transporting control of printing paper P; and

FIG. 14 is a graph showing another example of a relation between the rotating speed of each roller and the time when one sheet of printing paper P is transported by both PF drive roller and the rear paper feeding roller.

### DETAILED DESCRIPTION OF THE EMBODIMENTS

Referring to the drawings, a printer and a method of controlling the printer of an embodiment of the present invention will be explained below.

### (Outline of Structure of Printer)

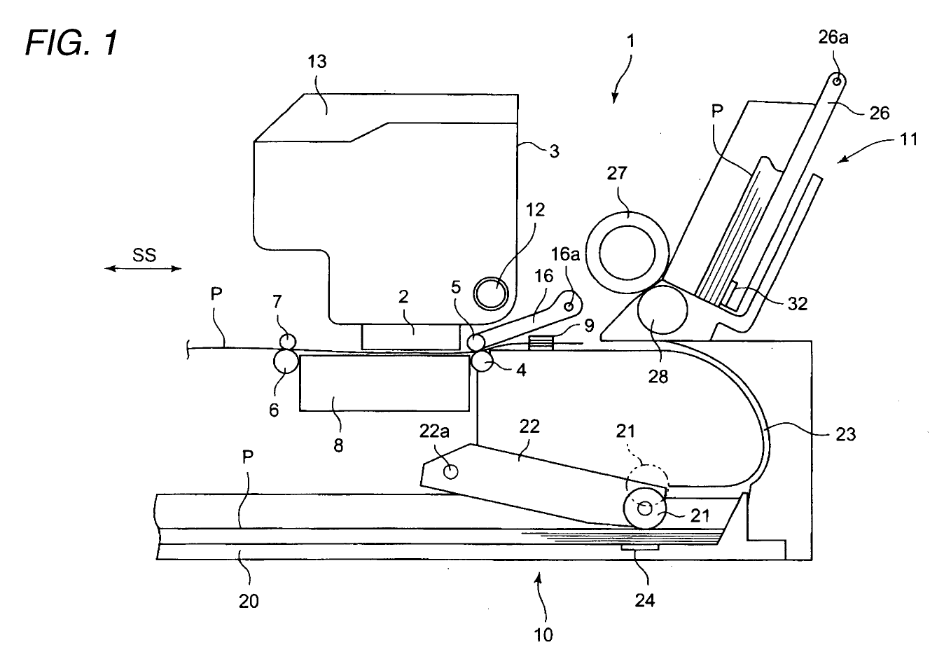

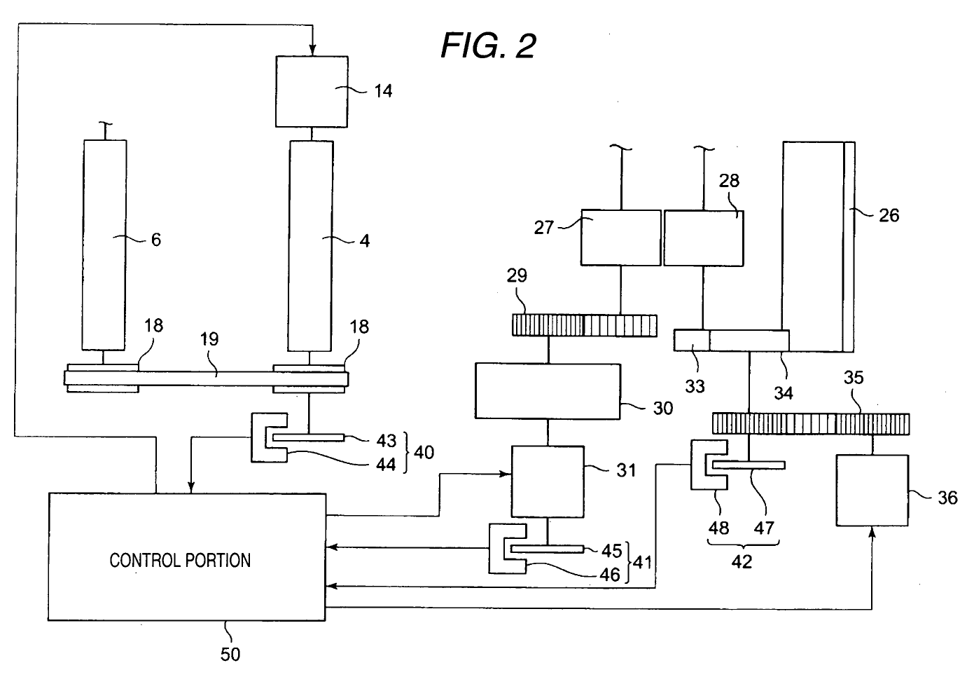

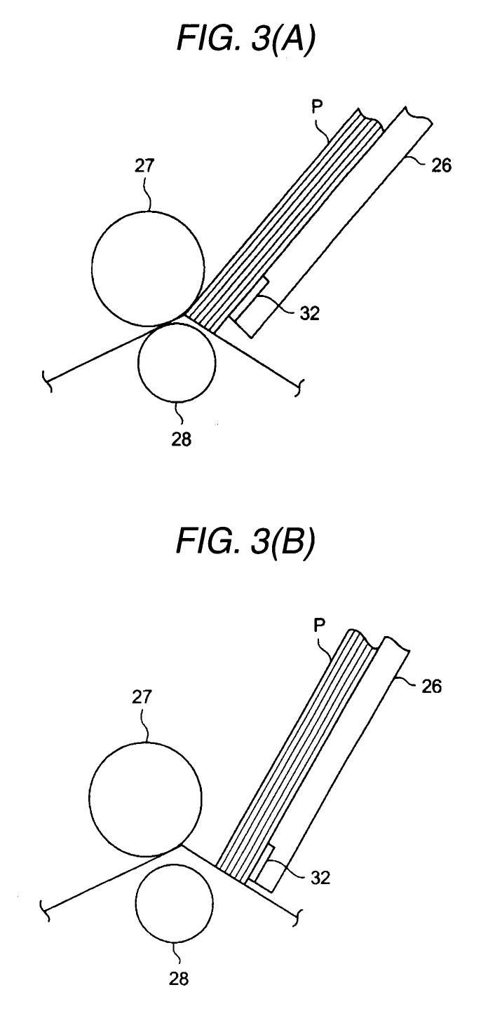

FIG. 1 is a side view showing an outline of the structure of a primary portion of a printer 1 of an embodiment of the present invention. FIG. 2 is a schematic illustration schematically showing an outline of the structure of a drive portion such as PF drive roller 4 and others shown in FIG. 1. FIGS. 3(A) and 3(B) are views for explaining actions of a rear paper feeding hopper 26 and a retard roller 28 shown in FIG. 1. FIG. 3(A) is a view showing a state in which lower end portions of the rear hopper 26 and the retard roller 28 are raised up so that printing paper P can be fed into the printer 1. FIG. 3(B) is a view showing a state in which the lower end portions of the rear hopper 26 and the retard roller 28 are lowered so that printing paper P can not be fed into the printer 1.

The printer 1 of this embodiment is an ink jet printer to conduct printing on printing paper P, which is a printing medium, by jetting out ink drops to printing paper P. As shown in FIG. 1, printing paper P can be fed from both sides of the front side (the left side in FIG. 1) and the rear side (the right side of FIG. 1). As shown in FIG. 1, this printer 1 includes: a carriage 3 on which a printing head 2 for jetting out ink drops is mounted; PF drive roller 4 which is a transporting roller for transporting printing paper P, which is fed from a front paper feeding cassette 20 or a rear paper feeding hopper 26 described later, in the vertical scanning direction SS; PF driven roller 5 for transporting printing paper P together with PF drive roller 4; a ejecting drive roller 6 which is a medium transporting roller for transporting printing paper P outside the printer 1; a ejecting driven roller 7 for transporting printing paper P together with the transporting roller 6; a platen 8 opposed to an ink jet face (the lower face of FIG. 1) of the printing head 2; a paper detection device 9 for detecting the passing of printing paper P fed from the rear paper feeding hopper 26; a front paper feeding mechanism 10 for supplying printing paper P from the front side to a printing region in which printing is conducted by the printing head 2; and a rear paper feeding mechanism 11 for supplying printing paper P from the rear side to the printing region in which printing is conducted by the printing head 2. In this connection, the printing medium in the present embodiment includes printing paper P such as plain paper used for conducting printing of usual documents, photographic paper used for conducting printing of photographs, and card board, the thickness of which is larger than that of the plain paper and the photographic paper. Except for the above printing paper, the printing medium in the present embodiment includes seals and transparent films such as OHP sheets.

The carriage 3 is connected to a carriage motor (CR motor) not shown through a belt and pulley not shown. This carriage 3 is driven by CR motor and moved at the same time in the horizontal scanning direction (the direction perpendicular to the surface of FIG. 1) being guided by a guide shaft 12. On the carriage 3, an ink cartridge 13, in which various types of ink to be supplied to the printing head 2 are accommodated, is mounted. Further, to the carriage 3, an end portion detection device (not shown) for detecting an end portion of printing paper P is attached.

A surface of PF drive roller 4 is coated with high friction material, the friction coefficient of which is high. As shown in FIG. 2, PF drive roller 4 is connected to the paper transporting motor (PF motor) 14, which is a motor for transporting, directly or through a gear not shown in the drawing. In this embodiment, PF motor 14 is a DC motor. In the present embodiment, concerning the method of controlling PF motor 14, PWM (Pulse Width Modulation) control, which is one of the methods of controlling voltage, is employed. At the same time, PID control is employed which is a method of control for converging the present rotating speed of the motor 14 to a target rotating speed by combining proportional control, integral control and derivative control with each other.

As shown in FIG. 1, PF driven roller 5 is pivotally held on the ejecting side of a driven roller holder 16 which is composed so that it can be oscillated around the rotating shaft 16a. The driven roller holder 16 is pushed counterclockwise in the drawing by a spring not shown so that PF driven roller 5 can be given a pushing force directed toward PF drive roller 4 at all times. When PF drive roller 4 is driven, PF driven roller 5 is rotated together with PF drive roller 4. That is, printing paper P is transported being interposed between PF drive roller 4 and PF driven roller 5. As shown in FIG. 1, PF driven roller 5 is arranged on the rear side of the printing head 2 together with PF drive roller 4.

As shown in FIG. 2, the ejecting drive roller 6 is connected to PF drive roller 4 through the transmission mechanism such as a pulley 18 and a belt 19. That is, the ejecting drive roller 6 is driven by PF motor 14. The ejecting drive roller 6 is rotated synchronously with PF drive roller 4. That is, the ejecting drive roller 6 is rotated at the substantially same circumferential speed as that of PF drive roller 4. The ejecting driven roller 7 is given a pushing force directed to the ejecting drive roller 6 at all times by a spring not shown in the same manner as that of PF driven roller 5. When the ejecting drive roller 6 is driven, the ejecting driven roller 7 is also rotated together with the ejecting drive roller 6. That is, printing paper P is transported under the condition that it is interposed between the ejecting drive roller 6 and the ejecting driven roller 7. As shown in FIG. 1, the ejecting drive roller 6 and the ejecting driven roller 7 are arranged on the front side (the ejecting side) the printing head 2.

The paper detection device 9 is an optical type detection device in which a light emitting element and a light receiving element are arranged being opposed to each other in the vertical direction. This paper detection device 9 detects an end portion in the width direction of printing paper P passing through between the light emitting element and the light receiving element. The paper detection device 9 is arranged between PF drive roller 4, which is arranged on the rear side of the carriage 3, and the rear paper feeding mechanism 11. By this paper detection device 9, at the time of continuous printing of printing paper P, a trailing end of the preceding printing paper P and a leading end of the succeeding printing paper P can be detected.

The front paper feeding mechanism 10 includes: a front paper feeding cassette 20 in which printing paper P before printing fed from the front side is set; a front paper feeding roller 21 for feeding printing paper P, which is set in the front paper feeding cassette 20, into the printer 1, that is, toward a printing region in which printing is conducted with the printing head 2; an arm 22 for pivotally holding the front paper feeding roller 21; and a transporting passage 23 in which printing paper P, which has been taken in by the front paper feeding roller 21, passes through. In the present embodiment, as shown in FIG. 1, printing paper P, which has been fed from the front side, is first transported toward the rear side and then the transporting direction of printing paper P is inverted by the transporting passage 23, the configuration of which is formed into a substantially arcuate shape. Then, printing paper P is transported toward the front side.

A friction member 24, which is made of material such as cork, the friction coefficient of which is relatively high, is attached onto a bottom face of the front paper feeding cassette 20. This friction member 24 fulfills a function of preventing the occurrence of double feeding of printing paper P. The front paper feeding roller 21 is attached to a leading end portion of the arm 22 capable of being oscillated around the rotary shaft 22a. In a case where paper feeding is conducted from the front side, this front paper feeding roller 21 comes into pressure contact with an upper face of printing paper P as shown by the solid line in FIG. 1. In a case where paper feeding is not conducted from the front side, this front paper feeding roller 21 is separated from the upper face of printing paper P as shown by two-dotted chain line in FIG. 1. The front paper feeding roller 21 transports printing paper P inside the printer 1 until a leading end portion of printing paper P reaches PF drive roller 4 and PF driven roller 5. When the leading end portion of printing paper P has reached PF drive roller 4 the front paper feeding roller 21 is separated from an upper face of printing paper P. After that, printing paper P is transported by PF drive roller 4, PF driven roller 5, the ejecting drive roller 6 and the ejecting driven roller 7. In this connection, the front paper feeding roller 21 may be contacted at all times with the upper face of printing paper P which has been set in the front paper feeding cassette 20.

The rear paper feeding mechanism 11 includes: a rear paper feeding hopper 26 which is a medium setting portion in which printing paper P before printing fed from the rear side is set; a rear paper feeding roller 27 for feeding printing paper P, which is set in the rear paper feeding hopper 26, into the printer 1, that is, toward a printing region in which printing is conducted with the printing head 2; and a retard roller 28 for preventing the occurrence of double feeding of printing paper P.

As shown in FIG. 2, the rear paper feeding roller 27 is connected to ASF motor 31, which is a motor used for feeding, through a gear train 29 and a planetary gear train 30. The front paper feeding roller 21 is also connected to ASF motor 31 through the planetary gear train 30 and others. In FIG. 2, the front paper feeding roller 21 is omitted. In the present embodiment, when ASF motor 31 is rotated in one direction, by the action of the planetary gear train 30, the rear paper feeding roller 27 is rotated and printing paper P is fed inside the printer 1 from the rear side. When ASF motor 31 is rotated in the other direction, by the action of the planetary gear train 30, the front paper feeding roller 21 is rotated and printing paper P is fed inside the printer 1 from the front side.

In this embodiment, ASF motor 31 is a DC motor. In the present embodiment, in the same manner as that of PF motor 14, concerning the method of controlling ASF motor 31, PWM control, which is one of the methods of controlling voltage, is employed. At the same time, PID control is employed which is a method of control for converging the present rotating speed of the ASF motor 31 to a target rotating speed by combining proportional control, integral control and derivative control with each other.

As shown in FIG. 1, the rear paper feeding hopper 26 is a plate-shaped member on which printing paper P can be put. The rear paper feeding hopper 26 can be oscillated around a rotary shaft 26a provided on the upper end side thereof. At a lower end portion of the face of the rear paper feeding hopper 26 on which printing paper P is put, a friction member 32 is attached which is made of material such as cork, the friction coefficient of which is relatively high. The friction member 32 fulfills a function of preventing the occurrence of double feeding of printing paper P together with the retard roller 28.

The retard roller 28 is arranged at a position opposed to an oblique lower side of the rear paper feeding roller 27. An outer circumference of this retard roller 28 is formed out of a member made of material, the friction coefficient of which is high. As shown in FIG. 2, the retard roller 28 is pivotally held by an arm 33 composed in such a manner that the arm 33 can be oscillated around a predetermined rotary shaft (not shown).

As schematically shown in FIG. 2, when the cam 34 is rotated, the rear paper feeding hopper 26 is oscillated around the rotary shaft 26a. By this oscillation, a lower end portion of the rear paper feeding hopper 26 is pushed toward the rear paper feeding roller 27 or separated from the rear paper feeding roller 27. The arm 33, by which the retard roller 28 is held, is also oscillated by the rotation of the cam 34. By this oscillation, the retard roller 28 comes into pressure contact with the rear paper feeding roller 27 or is separated from the rear paper feeding roller 27.

To be specific, as shown in FIG. 2, when the cam 34, which is connected to ASF sub-motor 36 through the gear train 35, is driven by ASF sub-motor 36 and rotated by a predetermined angle, as shown in FIG. 3(A), the lower end portion of the rear paper feeding hopper 26 and the retard roller 28 are raised. That is, the lower end portion of the rear paper feeding hopper 26 is pushed toward the rear paper feeding roller 27 and the retard roller 28 comes into pressure contact with the rear paper feeding roller 27. When the cam 34 is rotated by a predetermined angle in this state, as shown in FIG. 3(B), the lower end portion of the rear paper feeding hopper 26 and the retard roller 28 are lowered. That is, the lower end portion of the rear paper feeding hopper 26 is separated from the rear paper feeding roller 27, and the retard roller 28 is also separated from the rear paper feeding roller 27. In this connection, ASF sub-motor 36 in this embodiment is a DC motor.

FIG. 3(A) shows a state in which printing paper P can be fed inside the printer 1. When the rear paper feeding roller 27 is rotated in this state, an uppermost sheet of printing paper P, which is one of the sheets of printing paper P which have been set in the rear paper feeding hopper 26, passes through a pressure contact portion formed between the rear paper feeding roller 27 and the retard roller 28 and is sent to the ejecting side. The second sheet of printing paper P and the sheets of printing paper P after that are obstructed from being transported to the ejecting side by an action conducted by the retard roller 28. FIG. 3(B) shows a state in which sheets of printing paper P can not fed inside the printer 1 from the rear side.

As shown in FIG. 2, the printer 1 of the present embodiment includes: PF encoder 40 which is a first encoder for detecting a rotating distance (rotating position) and a rotating speed of PF motor 14; ASF encoder 41 which is a second encoder for detecting a rotating distance (rotating position) and a rotating speed of ASF motor 31; and a position detecting device 42 for detecting a rotating position of the cam 34.

PF encoder 40 includes: a rotary scale 43 fixed to a rotary shaft of PF drive roller 4; and a photo sensor 44 having a light emitting element and a light receiving element not shown arranged so that an outer circumferential portion of the rotary scale 43 can be interposed between them. An output signal outputted from this PF encoder 40 is inputted into the control portion 50 for conducting various control of the printer 1. The rotary scale 43 is formed out of a disk-shaped thin plate made of transparent plastics. At the circumferential edge of this rotary scale 43, a plurality of marks (not shown) are arranged at regular angular intervals in the circumferential direction. To be specific, along the outer circumference of one face of the rotary scale 43, black marks are printed at regular angular intervals in the circumferential direction. These printed black marks are used as marks. It is possible that the rotary scale 43 is formed out of a thin stainless steel plate and that slits penetrating the rotary scale 43 are formed in the rotary scale 43 instead of the marks described above.

ASF encoder 41 includes: a rotary scale 45 fixed to an output shaft of ASF motor 31; and a photo sensor 46 having a light emitting element and a light receiving element not shown arranged so that an outer circumferential portion of the rotary scale 45 can be interposed between them. An output signal of this ASF encoder 41 is inputted into the control portion 50. In the same manner as that of the rotary scale 43, the rotary scale 45 is formed out of a transparent plastic thin plate or a stainless steel thin plate. Marks or slits are formed in the rotary scale 45.

The position detection device 42 includes: a detection plate 47 fixed to a rotary shaft of the cam 34; and a photo sensor 48 having a light emitting element and a light receiving element not shown arranged so that an outer circumferential portion of this detection plate 47 can be interposed between them. An output signal outputted from the position detection device 42 is also inputted into the control portion 50.

### (Outline of Structure of Control Section)

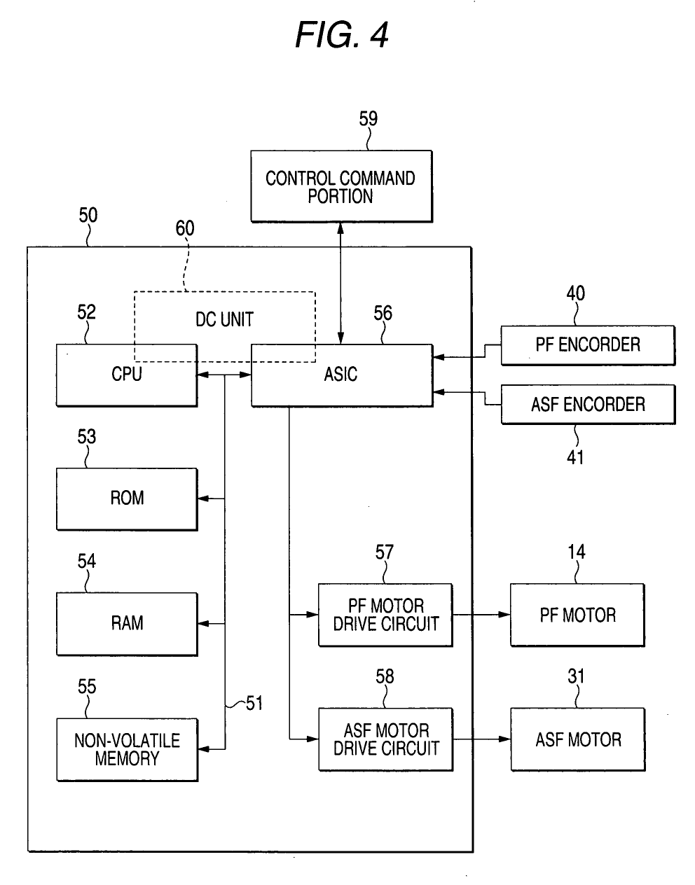

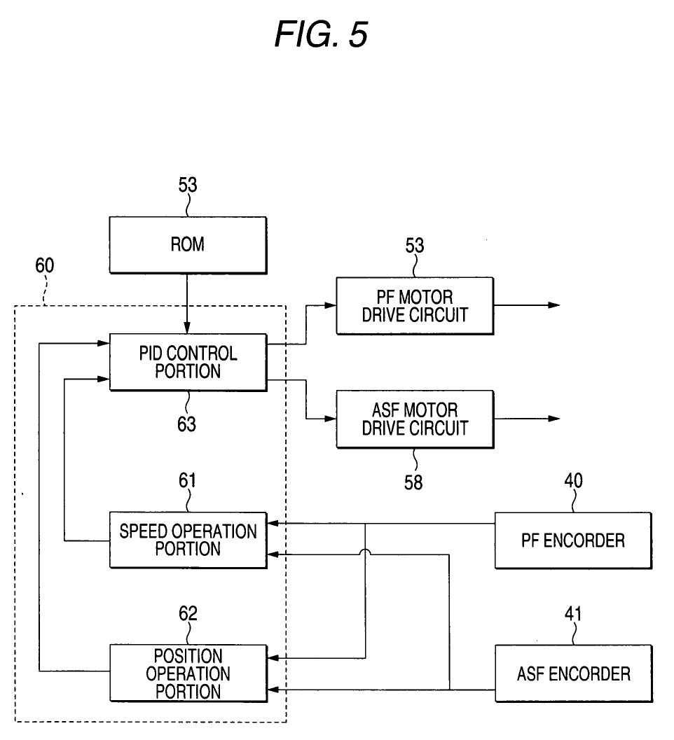

FIG. 4 is a block diagram showing an outline of the structure of the control portion 50 and its peripheral devices shown in FIG. 2. FIG. 5 is a block diagram showing a model of a portion of the inner structure of DC unit 60 shown in FIG. 4. In this connection, FIGS. 4 and 5 only show a structure of the control portion 50 related to control of PF motor 14 and ASF motor 31.

As shown in FIG. 4, the control portion 50 includes: a bus 51, CPU 52, ROM 53, RAM 54, non-volatile memory 55, ASIC 56, PF motor drive circuit 57 and ASF motor drive circuit 58.

CPU 52 conducts arithmetic processing for executing a control program of the printer 1 stored in ROM 53 and the non-volatile memory 55. Further, CPU 52 conducts other arithmetic processing. ROM 53 stores a control program for controlling the printer 1 and also stores data necessary for processing. For example, ROM 53 stores: a target speed table on which a target rotating speed with respect to a rotating time or a rotating speed of PF motor 14 used for PID control is set; and a target speed table on which a target rotating speed with respect to a rotating time or a rotating distance of ASF motor 31 is set. In RAM 54, a program which is being executed by CPU 52 and data which is in the middle of arithmetic operation are temporarily accommodated. The non-volatile memory 55 stores various data which must be stored even after an electric power supply to the printer 1 is turned off.

As shown in FIG. 4, various signals sent from PF encoder 40 and ASF encoder 41 are inputted into ASIC 56. ASIC 56 supplies signals for controlling PF motor 14 and ASF motor 31 to PF motor drive circuit 57 and ASF motor drive circuit 58. An interface circuit is incorporated into this ASIC 56, so that a printing signal supplied from the control command portion 59 can be received by ASIC 56.

Speed control of PF motor 14 and ASF motor 31 is conducted when CPU 52 and ASIC 56 cooperate with each other. That is, DC unit 60, which is a control circuit for conducting speed control of PF motor 14 and ASF motor 31 which are DC motors, is composed by a portion of CPU 52 and a portion of ASIC 56. Specifically, in DC unit 60, a portion of CPU 52 conducts various arithmetic operation for conducting speed control of PF motor 14 and ASF motor 31 according to various signals inputted from PF encoder 40 or ASF encoder 41 through ASIC 56. In DC unit 60, a portion of ASIC 56 receives a signal from PF encoder 40 or ASF encoder 41. Alternatively, in DC unit 60, a portion of ASIC 56 outputs a signal to PF motor drive circuit 57 and ASF motor drive circuit 58 according to a result of arithmetic operation conducted in CPU 52.

As described above, PF motor 14 and ASF motor 31 of the present embodiment are controlled by PID control. Therefore, as schematically shown in FIG. 5, DC unit 60 includes a speed operation portion 61, a position operation portion 62 and PID control portion 63 for conducting PID control.

The speed operation portion 61 calculates the present rotating speed of PF motor 14 according to a signal inputted from PF encoder 40 and outputs a signal corresponding to this rotating speed to PID control portion 63. The speed operation portion 61 calculates the present rotating speed of ASF motor 31 according to a signal inputted from ASF encoder 41 and outputs a signal corresponding to this rotating speed to PID control portion 63.

The position operation portion 62 calculates the present rotating distance of PF motor 14 according to a signal inputted from PF encoder 40 and outputs a signal corresponding to this rotating distance to PID control portion 63. The position operation portion 62 calculates the present rotating distance of ASF motor 31 according to a signal inputted from ASF encoder 41 and outputs a signal corresponding to this rotating distance to PID control portion 63.

First, PID control portion 63 calculates a positional deviation, which is a distance between the target stop position and the present rotating distance, from a signal of the target stop position corresponding to the next stop position of printing paper P, which has been read out from ROM 53, and from a signal of the present rotating distance inputted from the position operation portion 62. After that, PID control portion 63 reads out a target rotating speed corresponding to the present rotating distance of PF motor 14 or ASF motor 31 from the target speed table, which is stored in ROM 53, according to this positional deviation. After that, PID control portion 63 calculates a speed deviation, which is a difference between the target rotating speed and the present rotating speed, from the present rotating speed signal and the target rotating speed signal inputted from the speed operation portion 61. After that, PID control portion 63 calculates a proportional control value, an integral control value and a derivative control value according to the speed deviation and adds these control values and outputs PID control signal. In the present embodiment, since PF motor 14 and ASF motor 31 are subjected to PWM control as described before, PID control signal is a pulse-like signal which is repeatedly turned on and off by a predetermined switching period.

PF motor drive circuit 57 controls to drive PF motor 14 by a signal (specifically, a signal sent from ASIC 56) sent from DC unit 60. In the present embodiment, since PF motor 14 is subjected to PWM control, PF motor drive circuit 57 outputs PWM drive signal. In the same manner, since ASF motor drive circuit 58 controls to drive ASF motor 31 by a signal sent from DC unit 60, ASF motor drive circuit 58 outputs PWM drive signal.

A bus 51 is a signal line connecting each component of the control portion 50 described above. This bus 51 connects CPU 52, ROM 53, RAM 54, non-volatile memory 55 and ASIC 56 with each other so that data can be given and received by the components.

### (Outline of Action of Printer)

In the printer 1 described above, printing paper P, which has been fed by the front paper feeding roller 21 from the front paper feeding cassette 20 into the printer 1, or printing paper P, which has been fed by the rear paper feeding roller 27 from the rear paper feeding hopper 26 into the printer 1, is intermittently transported by PF drive roller 4 in the vertical scanning direction SS. At the time of stop of this intermittent transporting, the carriage 3 is reciprocated in the horizontal scanning direction. When the carriage 3 is reciprocated, the printing head 2 jets out ink drops so as to conduct printing on printing paper P. After printing on printing paper P has been finished, printing paper P is transported outside the printer 1 by the ejecting drive roller 6.

When PF drive roller 4 is rotated, that is, when PF motor 14 is rotated, a signal is outputted from PF encoder 40. This signal is inputted into the control portion 50. From the thus inputted signal, the control portion 50 detects a rotating distance and a rotating speed of PF drive roller 4, that is, a rotating distance and a rotating speed of PF motor 14. According to the thus detected rotating distance (rotating position) and rotating speed of PF motor 14, the control portion 50 variously controls the printer 1. In the same manner, when the rear paper feeding roller 27 is rotated, that is, when ASF motor 31 is rotated, a signal sent from ASF encoder 41 is inputted into the control section 50. From the thus inputted signal, the control portion 50 detects a rotating distance and a rotating speed of the rear paper feeding roller 27, that is, a rotating distance and a rotating speed of ASF motor 31. According to the thus detected rotating distance (rotating position) and the rotating speed of ASF motor 31, the control portion 50 variously controls the printer 1.

In the present embodiment, at the time of continuous printing in which a plurality of sheets of printing paper P are continuously printed, a method of controlling PF motor 14 and ASF motor 31 at the time of a draft printing mode (an economy printing mode), in which high speed printing is conducted while a consumption of ink is being saved although resolution is made to deteriorate, is different from a method of controlling PF motor 14 and ASF motor 31 at the time of a printing mode (a normal printing mode) in which printing is conducted at a predetermined resolution or at a higher resolution than the predetermined resolution except for the draft printing mode. That is, at the time of continuous printing, the control portion 50 conducts different transporting control of printing paper P between the draft printing mode and the normal printing mode. A case in which printing paper P is fed inside the printer 1 from the rear side is taken up as an example, and a method of controlling transporting of printing paper P in the printer 1 will be explained below, that is, a method of controlling PF motor 14 and ASF motor 31 will be explained below. In this connection, in the present embodiment, the draft printing mode is the first printing mode in which at least synchronous transporting control described later is conducted. The normal printing mode is the second printing mode in which separate transporting control described later is conducted.

### (Method of Transporting Control of Printing Paper)

### [Controlling Method in the Normal Printing Mode]

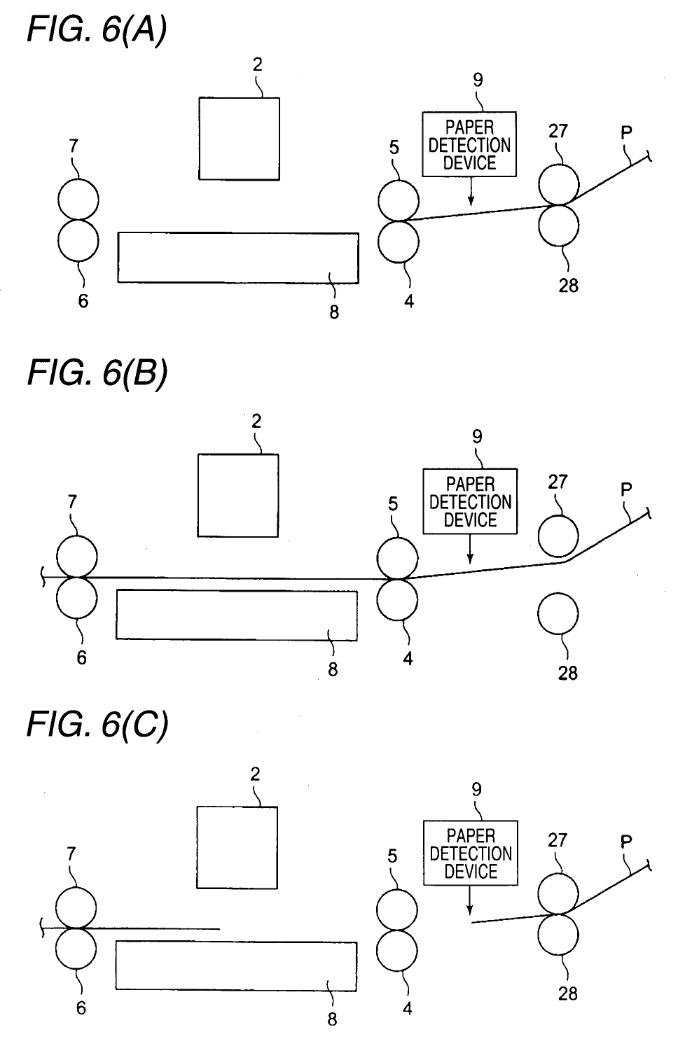

FIGS. 6(A), 6(B) and 6(C) are schematic illustrations for explaining a method of transporting control of printing paper P at the time of continuous printing in the normal printing mode of the present embodiment. FIG. 6(A) shows a state in which the first sheet of printing paper P is fed. FIG. 6(B) shows a state in which sheets of printing paper P are intermittently transported in the printing action conducted on printing paper P. FIG. 6(C) shows a state in which printing conducted on the preceding sheet of printing paper P is finished and the following sheet of printing paper P is fed.

In the normal printing mode of the present embodiment, in the same manner as that of the conventional case, printing paper P, which is set in the rear paper feeding hopper 26, is transported and fed to PF drive roller 4 by the rear paper feeding roller 27. After that, printing paper P is transported by PF drive roller 4 and the ejecting drive roller 6. That is, in the normal printing mode, PF motor 14 and ASF motor 31 are individually controlled so that printing paper P can be transported. This transporting control of printing paper P is defined as separate transporting control, hereinafter.

Specifically, operation is performed as follows. First, as shown in FIG. 3(A), a lower end portion of the rear paper feeding hopper 26 is pushed toward the rear paper feeding roller 27. Under the condition that the retard roller 28 comes into pressure contact with the rear paper feeding roller 27, ASF motor 31 is driven so as to rotate the rear paper feeding roller 27. Then, as shown in FIG. 6(A), by the rear paper feeding roller 27, a leading end portion of printing paper P is transported to a position where PF drive roller 4 and PF driven roller 5 are arranged. In this way, printing paper P is fed inside the printer 1.

When the leading end portion of printing paper P is transported to the position where PF drive roller 4 and PF driven roller 5 are arranged, as shown in FIGS. 3(B) and 6(B), a lower end portion of the rear paper feeding hopper 26 is separated from the rear paper feeding roller 27 and the retard roller 28 is also separated from the rear paper feeding roller 27. ASF motor 31 is stopped and the rear paper feeding roller 27 is also stopped. In this state, PF motor 14 is intermittently driven and paper feeding roller P is intermittently transported by PF drive roller 4. At the same time, ink drops are jetted out from the printing head 2, so that printing is conducted on printing paper P. In this connection, after the leading end portion of printing paper P has arrived at a position of the ejecting drive roller 6 and the ejecting driven roller 7, printing paper P is intermittently transported by PF drive roller 4 and the ejecting drive roller 6. In the normal printing mode, by utilizing the end portion detection device attached to the carriage 3, a so-called “cue of the printing paper P”, in which the leading end portion of printing paper P and the printing head 2 are positioned to each other, is conducted.

After printing conducted on printing paper P has been finished, as shown in FIG. 6(C), PF motor 14 is continuously driven and printing paper P is transported outside the printer 1 by the ejecting drive roller 6. After the preceding printing paper P has been transported or simultaneously when the preceding printing paper P has been transported, the lower end portion of the rear paper feeding hopper 26 and the retard roller 28 are raised up. At the same time, ASF motor 31 is driven so that the rear paper feeding roller 27 can be rotated. As shown in FIG. 6(C), printing paper P is transported and fed again to the position where PF drive roller 4 and PF driven roller 5 are arranged.

In the normal printing mode, PF motor 14 and ASF motor 31 are subjected to PID control according to the respective target speed tables which are individually set and stored in ROM 53. At the time of printing of only one sheet of printing paper, irrespective of whether it is a draft printing mode or it is a normal printing mode, printing paper P, which is set in the rear paper feeding hopper 26, is first transported to PF drive roller 4 by the rear paper feeding roller 27 so that printing paper P can be fed inside the printer. After that, printing paper P is transported by PF drive roller 4 and so forth. That is, at the time of printing one sheet of printing paper, separate transporting control is performed.

### [Control Method in Draft Printing Mode]

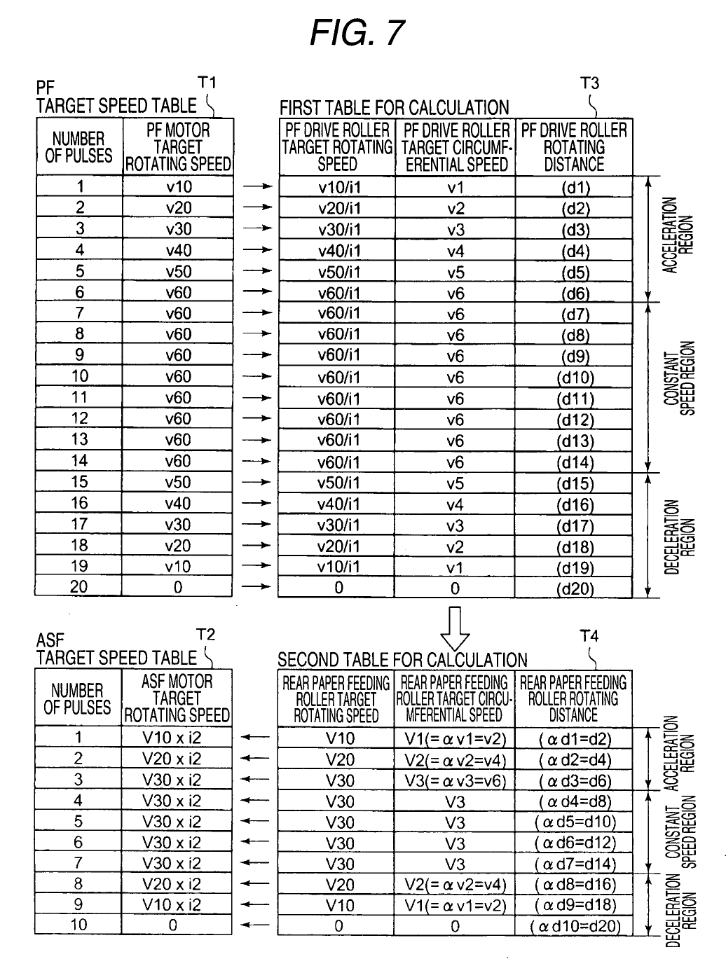

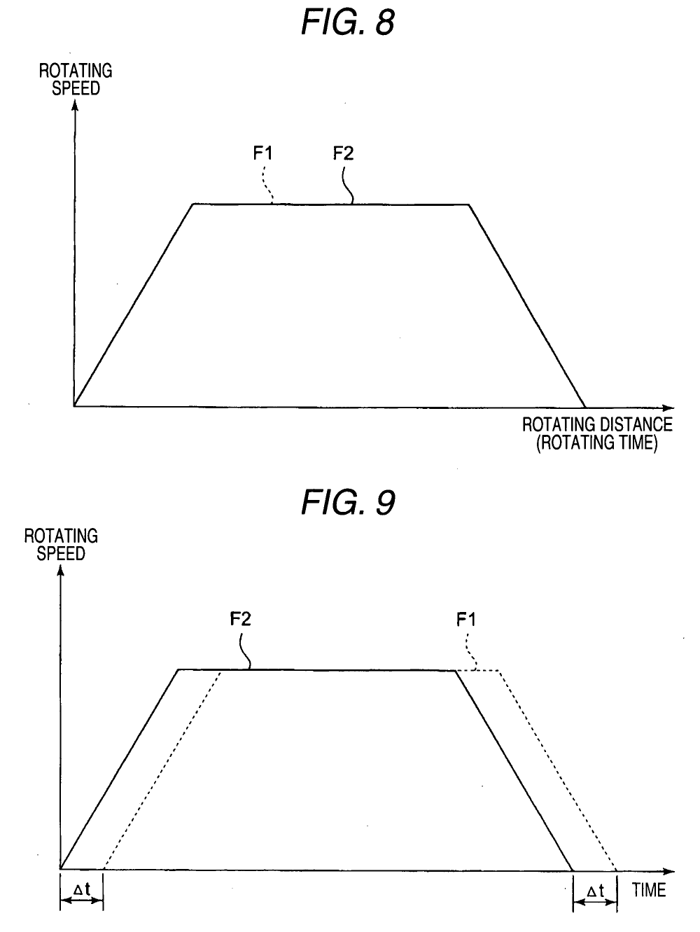

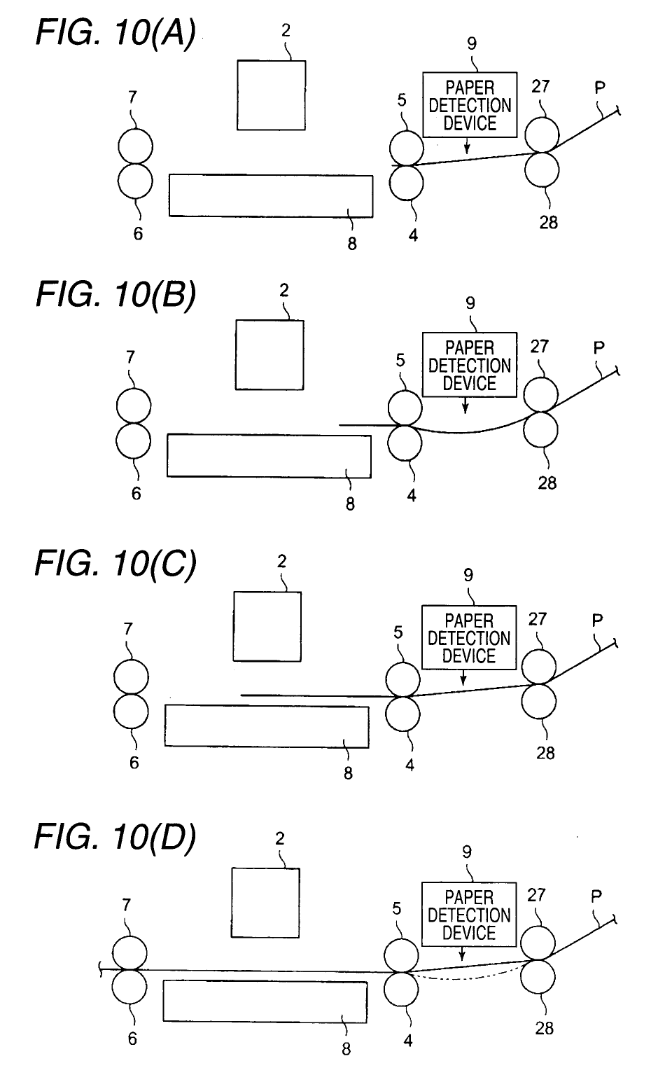

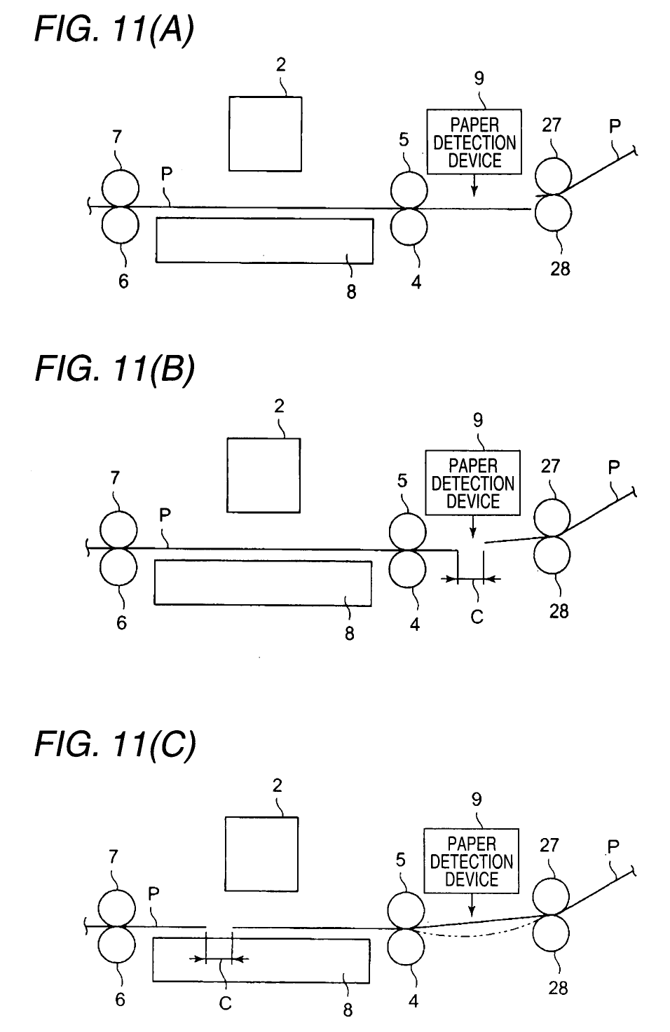

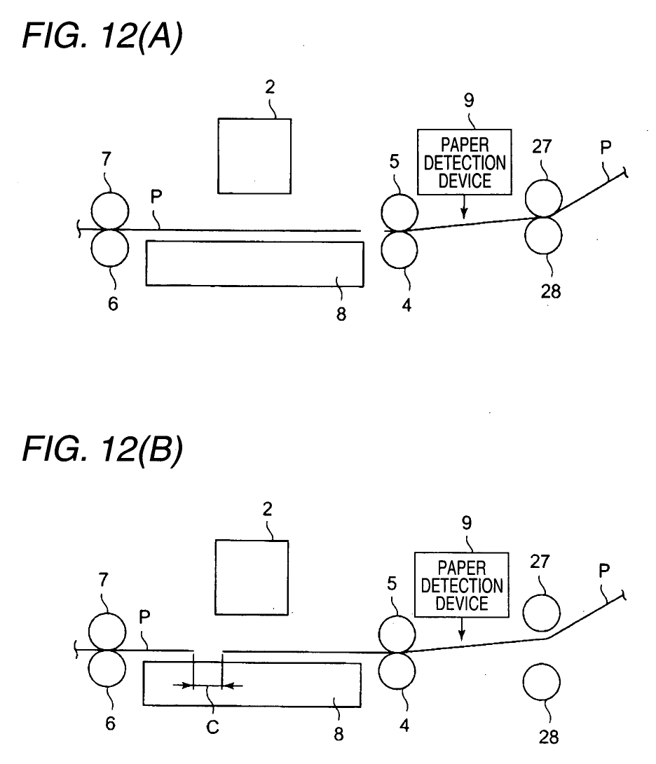

FIG. 7 is a target speed table in which an example of the target speed stored in ROM 53 shown in FIG. 4 is schematically shown. FIG. 8 is a graph showing speed profiles F1, F2 of PF drive roller 4 and the rear paper feeding roller 27 made according to the target speed table shown in FIG. 7. FIG. 9 is a graph showing a relation between the rotating speed of each roller and the time when one sheet of printing paper P is transported by both PF drive roller 4 and the rear paper feeding roller 27. FIGS. 10(A), 10(B) 10(C) and 10(D) are schematic illustrations for explaining a control method when the first sheet of printing paper P is transported at the time of continuous printing in the draft printing mode. FIGS. 11(A), 11(B) and 11(C) are schematic illustrations for explaining a control method when two continuous sheets of printing paper P are transported at the time of continuous printing in the draft printing mode. FIGS. 12(A) and 12(B) are schematic illustrations for explaining a control method when the last sheet of printing paper P is transported at the time of continuous printing in the draft printing mode.

In this connection, FIG. 10(A) is a view showing a state in which printing paper P is fed. FIG. 10(B) is view showing a state in which printing paper P is transported to a position of the printing head 2 by both PF drive roller 4 and the rear paper feeding roller 27. FIG. 10(C) is view showing a state in which one sheet of printing paper P, which is transported by both PF drive roller 4 and the rear paper feeding roller 27, is transported to and stopped at a position of the printing head 2. FIG. 10(D) is a view showing a state in which printing paper P is intermittently transported at the time of printing action conducted on printing paper P. FIG. 11(A) is a view showing a state in which a trailing end of the preceding sheet of printing paper P has left the rear paper feeding roller 27 and the following sheet of printing paper has started to be transported by the rear paper feeding roller 27. FIG. 11(B) is a view showing a state in which the trailing end of the preceding sheet of printing paper P and the leading end of the following sheet of printing paper P are located between PF drive roller 4 and the rear paper feeding roller 27. FIG. 11(C) is a view showing a state in which one sheet of printing paper. P transported by both PF drive roller 4 and the rear paper feeding roller 27 is transported to a position of the printing head 2. FIG. 12(A) is a view showing a state in which a leading end of the last sheet of printing paper P is transported to a position of PF drive roller 4. FIG. 12(B) is a view showing a state after a leading end of the last sheet of printing paper P has been transported to a position of PF drive roller 4.

In the draft printing mode of the present embodiment, for the transporting of printing paper P after printing paper P has been transported by the rear paper feeding roller 27 from the rear paper feeding hopper 26 to PF drive roller 4, in addition to PF drive roller 4 and the ejecting drive roller 6, the rear paper feeding roller 27 is used. That is, in the draft printing mode, PF drive roller 4 and the ejecting drive roller 6, which are driven by PF motor 14, and the rear paper feeding roller 27 driven by ASF motor 31 cooperate with each other. Due to this cooperation of the rollers, printing paper P can be transported at the time of printing action. Therefore, in the draft printing mode, PF drive roller 4 and the ejecting drive roller 6 must be rotated synchronously with the rear paper feeding roller 27, that is, at the same circumferential speed. Therefore, in the draft printing mode of the present embodiment, by synchronous control in which PF drive roller 4 and the ejecting drive roller 6 are rotated synchronously with the rear paper feeding roller 27, PF motor 14 and ASF motor 31 are controlled, so that printing paper P can be transported. This transporting control of transporting printing paper P is defined as synchronous transporting control, hereinafter.

In the draft printing mode of the present embodiment, in a case where synchronous transporting control is conducted, start correcting control is conducted in such a manner that when one sheet of printing paper P is transported by both PF drive roller 4 and the rear paper feeding roller 27, the start time of PF motor 14 is delayed from the start time of ASF motor 31. Further, in the draft printing mode of the present embodiment, the last sheet of printing paper P at the time of continuous printing is transported and fed to PF roller 4 by the rear paper feeding roller 27 and then transported by PF drive roller 4 and the ejecting drive roller 6. That is, the last sheet of printing paper P at the time of continuous printing is transported by separate transporting control.

A method of controlling the transporting of printing paper P in the draft printing mode will be explained in detail as follows.

As described before, PF motor 14 and ASF motor 31 are controlled by PID control. Therefore, as a first target speed table in which a target rotating speed corresponding to the rotating time or the rotating distance of PF motor 14 for conducting synchronous control is set, for example, PF target speed table T1 is stored in ROM 53. As a second target speed table in which a target rotating speed corresponding to the rotating time or the rotating distance of ASF motor 31 for conducting synchronous control is set, for example, ASF target speed table T2 is stored in ROM 53. Concerning this matter, refer to FIG. 7. First, a method of setting the first and the second target speed table will be explained below.

In the present embodiment, the first and the second target speed table are set so that the first speed profile and the second speed profile can be substantially the same. In this case, the first speed profile is made according to the first target speed table, for example, according to PF target speed table T and shows a relation between the rotating time or the rotating distance and the target circumferential speed (the target transporting speed of printing paper P by PF drive roller 4). For example, the first speed profile is PF speed profile F1 made according to PF target speed table T1. The second speed profile is made according to the second target speed table, for example, according to ASF target speed table T2 and shows a relation between the rotating time or the rotating distance and the circumferential speed (the target transporting speed of printing paper P by the rear paper feeding roller 27). For example, the second speed profile is paper feeding speed profile F2 made according to ASF target speed table T2.

In the present embodiment, for example, ASF target speed table T2 is set on the basis of PF target speed table T1. Specifically, ASF target speed table T2 is set according to ratio α of resolving power of PF encoder 40 to resolving power of ASF encoder 41 and also according to the first target speed table T1.

In this case, α of resolving power of PF encoder 40 to resolving power of ASF encoder 41, that is, (resolving power of ASF encoder 41)/(resolving power of PF encoder 40) is calculated as follows. Resolving power of PF encoder 40 is πD1/(N1×i1) in a case where a rotating distance of PF drive roller 4 is used as reference, wherein diameters of PF drive roller 4 and the rear paper feeding roller 27 are respectively D1 and D2, numbers of marks formed on the rotary scales 43, 45 are respectively N1 and N2, a reduction ratio from PF motor 14 to PF drive roller 4 is i1 and a reduction ratio from ASF motor 31 to the rear paper feeding roller 27 is i2. In a case where a rotating distance of the rear paper feeding roller 27 is used as reference, resolving power of ASF encoder 41 is πD2/(N2×i2). Accordingly, ratio α is expressed by the following expression.

α=(D2×N1×i1)/(D1×N2×i2)

In this connection, in order to explain a method of setting ASF target speed table T2 of the present embodiment so as to facilitate the understanding, ratio α is set at 2, that is, α=2. A rotating distance (a transporting distance of printing paper P by PF transporting roller 4) of PF drive roller 4 corresponding to one pulse of the pulse signal (PF pulse signal), which is inputted from PF encoder 40 into ASIC 56 corresponding to the forming pitch of marks formed on the rotary scale 43 or which is generated by ASCI 56 according to the input signal sent from PF encoder 40, is one half of a rotating distance (a transporting distance of printing paper P by rear paper feeding roller 27) of the rear paper feeding roller 27 corresponding to one pulse of the pulse signal (ASF pulse signal), which is inputted from ASF encoder 41 into ASIC 56 corresponding to the forming pitch of marks formed on the rotary scale 45 or which is generated by ASCI 56 according to the input signal sent from ASF encoder 41. In other words, in a case where PF drive roller 4 and the rear paper feeding roller 27 are rotated by the same distance, that is, in a case where the rotating distance is the same, the number of pulses of PF pulse signal is twice as large as the number of pulses of ASF pulse signal.

According to the thus calculated ratio α and the first target speed table T1, ASF target speed table T2 is set as follows. First, in order to more quickly transport and accurately stop printing paper P, PF target speed table T1 is set. For example, as shown in FIG. 7, in PF target speed table T1, a target rotating speed of PF motor 4 corresponding to the rotating distance (for example, the number of pulses of PF pulse signal) of PF motor 14 is set. In the example, shown in FIG. 7, a rotating distance (for example, an amount of intermittent transporting of printing paper P at the time of printing action) of PF drive roller 4 is a distance corresponding to 20 pulses of PF pulse signal. A region in which the number of pulses of PF pulse signal is 1 to 6 is an acceleration region in which PF motor 14 (PF drive roller 4 and the transporting roller 6) is controlled being accelerated. A region in which the number of pulses of PF pulse signal is 7 to 14 is a constant speed region in which PF motor 14 is controlled to be a constant speed. A region in which the number of pulses of PF pulse signal is 15 to 20 is a deceleration region in which PF motor 14 is controlled being decelerated.

For example, as shown in table T3 used for calculation of FIG. 7, from PF target speed table T1 and speed reduction ratio i1, a target rotating speed of PF drive roller 4 corresponding to the number of pulses of PF pulse signal is calculated. From the target rotating speed of PF drive roller 4 and diameter D1 of PF drive roller 4, a target circumferential speed of PF drive roller 4 corresponding to the number of pulses of PF pulse signal is calculated. In this connection, the first table T3 used for calculation is made for the purpose of setting ASF target speed table T2. The first table T3 used for calculation is not stored in ROM 53.

Since ratio α=2 as described above, a rotating distance corresponding to 20 pulses of PF pulse signal is the same as a rotating distance corresponding to 10 pulses of ASF pulse signal. That is, as shown in FIG. 7, in ASF target speed table T2 corresponding to PF target speed table T1, a target rotating speed of ASF motor 4 corresponding to 10 pulses of ASF pulse signal is set. Specifically, for example, as shown in table T4 used for calculation shown in FIG. 7, a target circumferential speed of the rear paper feeding roller 27 corresponding to the number of pulses of ASF pulse signal is calculated from ratio α and the target circumferential speed of PF drive roller 4 so that a target circumferential speed of PF drive roller 4 and a target circumferential speed of the rear paper feeding roller 27 can be substantially the same when a rotating distance of PF drive roller 4 and a rotating distance of the rear paper feeding roller 27 are the same with each other. That is, a target circumferential speed of the rear paper feeding roller 27 corresponding to the number of pulses of ASF pulse signal is calculated so that PF speed profile F1 and paper feeding speed profile F2 can be substantially the same with each other. After that, from the target circumferential speed of the rear paper feeding roller 27 and diameter D2 of the rear paper feeding roller 27, a target rotating speed of the rear paper feeding roller 27 corresponding to the number of pulses of ASF pulse signal can be calculated. From a target rotating speed of the rear paper feeding roller 27 and reduction ratio i2, a target rotating speed of ASF motor 4 corresponding to the number of pulses of ASF pulse signal is calculated and set in ASF target speed table T2. In this connection, in the same manner as that of the first table T3 used for calculation, the second table T4 used for calculation is made for the purpose of setting ASF target speed table T2. The second table T4 used for calculation is not stored in ROM 53.

PF speed profile F1, which is made according to PF target speed table T1 that has been set as described above, and paper feeding speed profile F2, which is made according to ASF target speed table T2, become substantially equal to each other as shown in FIG. 8. In this connection, in FIG. 8, PF speed profile F1, which is drawn by a broken line, and paper feeding speed profile F2, which is drawn by a solid line, completely overlap on each other.

As described above, according to PF target speed table T1 corresponding to PF speed profile F1, PF motor 14 is subjected to PID control. According to ASF target speed table T2 corresponding to paper feeding speed profile F2 which is substantially the same as PF speed profile F1, ASF motor 31 is subjected to PID control.

Specific explanations will be made into synchronous control conducted according to PF target speed table T1 and ASF target speed table T2 stored in ROM 53. First, explanations will be made into synchronous transporting control conducted when the first sheet of printing paper P is transported at the time of continuous printing.

When the first sheet of printing paper P is fed inside the printer 1, as shown in FIG. 3(A), a lower end portion of the rear paper feeding hopper 26 is pushed to the rear paper feeding roller 27 and the retard roller 28 comes into pressure contact with the rear paper feeding roller 27. In this state, ASF motor 31 is driven and the rear paper feeding roller 27 is rotated. At this time, the rear paper feeding roller 27 is rotated being controlled according to paper feeding speed profile F2. That is, ASF motor 31 is subjected to PID control according to ASF target speed table T2. As shown in FIG. 10(A), by the rear paper feeding roller 27, a leading end of printing paper P is transported to a position where PF drive roller 4 and PF driven roller 5 are arranged. In this way, printing paper P is fed inside the printer 1.

Simultaneously when AFS motor 31 is started, PF motor 14 is started. Therefore, PF drive roller 4 and the ejecting drive roller 6 are rotated. Therefore, a leading end of printing paper P appropriately enters between PF drive roller 4 and PF driven roller 5. At this time, PF drive roller 4 is subjected to rotation control according to PF speed profile F1. That is, PF motor 14 is subjected to PID control according to PF target speed table T1. In this way, in the draft printing mode, even when the first sheet of printing paper P is fed inside the printer 1, synchronous transporting control is conducted.

In this connection, in the draft printing mode, when the first sheet of printing paper P is fed inside the printer 1, synchronous transporting control may not be conducted. At the time of continuous printing conducted in the draft printing mode, until a leading end of the last sheet of printing paper P reaches the position where PF drive roller 4 and PF driven roller 5 are arranged, the lower end portion of the rear paper feeding hopper 26 and the retard roller 28 are raised up at all times as shown in FIG. 3(A).

After that, printing paper P is subjected to transporting control by synchronous transporting control. Specifically, the first sheet of printing paper P is intermittently transported by PF drive roller 4, which is rotated being controlled by PF speed profile F1, and by the rear paper feeding roller 27 which is rotated being controlled by paper feeding speed profile F2. That is, PF drive roller 4, which is rotated being controlled by PF speed profile F1, and the rear paper feeding roller 27, which is rotated being controlled by paper feeding speed profile F2, cooperate with each other and one sheet of printing paper P is transported. In other words, PF motor 14, which is subjected to PID control according to PF target speed table T1, and ASF motor 31, which is subjected to PID control according to ASF target speed table T2, are intermittently driven. First, as shown in FIGS. 10(B) and 10(C), printing paper P is transported so that a leading end of printing paper P can reach a position of the printing head 2 by one transporting action. In this connection, “cue of the printing paper P” conducted in the normal printing mode is not conducted in the draft printing mode.

As described above, in the draft printing mode of the present embodiment, when one sheet of printing paper P is transported by both PF drive roller 4 and the rear paper feeding roller 27, start correction control is conducted. That is, when one sheet of printing paper P is interposed between PF drive roller 4 and PF driven roller 5 and at the same time one sheet of printing paper P is interposed between the rear paper feeding roller 27 and the retard roller 28, the start time of PF motor 14 is delayed from the start time of ASF motor 31. Specifically, as schematically shown FIG. 9, the start time of PF motor 14, which is subjected to PID control according to PF target speed table T1, is delayed by Δt from the start time of ASF motor 31 which is subjected to PID control according to ASF target speed table T2 corresponding to paper feeding speed profile F2.

Therefore, as shown in FIG. 10(B), printing paper P is loosened between PF drive roller 4 and the rear paper feeding roller 27 at the time of transporting. At the time of stoppage of transporting, printing paper P is stretched as shown in FIG. 10(C). In this case, in the present embodiment, a leading end of printing paper P, which is set in the rear paper feeding hopper 26, is transported to a position where PF drive roller 4 is arranged by one transporting action. Alternatively, the leading end of printing paper P, which is set in the rear paper feeding hopper 26, is transported to the front side of the position where PF drive roller 4 is arranged by one transporting action. Therefore, for example, when the leading end of printing paper P is detected by the paper detection device 9, it is recognized that one sheet of printing paper P is transported by PF drive roller 4 and the rear paper feeding roller 27 in the following transporting action. Accordingly, in the following transporting action, start correcting control is conducted.

After that, printing paper P is intermittently transported by PF drive roller 4 and the rear paper feeding roller 27. When the leading end of printing paper P reaches a position of the ejecting drive roller 6 and the ejecting driven roller 7 after that, as shown in FIG. 10(D), printing paper P is intermittently transported by PF drive roller 4, the ejecting drive roller 6 and the rear paper feeding roller 27. That is, PF drive roller 4 and the rear paper feeding roller 27 cooperate with the ejecting drive roller 6 so as to transport printing paper P. In this intermittent transporting action, PF drive roller 4 and the ejecting drive roller 6 are subjected to rotation control according to PF speed profile F1, and the rear paper feeding roller 27 is subjected to rotation control according to paper feeding speed profile F2. That is, synchronous transporting control is conducted. Start correcting control is conducted. Therefore, printing paper P, which is being transported, is loosened between PF drive roller 4 and the rear paper feeding roller 27. At the time of stoppage, printing paper P is stretched. At the time of stoppage of printing paper P, printing is conducted on printing paper P.

Next, explanations will be made into synchronous control conducted when two continuous sheets of printing paper P are transported at the time of continuous printing.

As shown in FIG. 11(A), when a trailing end of the preceding printing paper P has left the rear paper feeding roller 27 and a transporting of the following printing paper P is started by the rear paper feeding roller 27, the starting time of PF motor 14, which is subjected to PID control according to PF target speed table T1, and the starting time of ASF motor 31, which is subjected to PID control according to ASF target speed table T2, are made to agree with each other. At this time, start correcting control is not conducted in synchronous transporting control. Therefore, even when synchronous control is conducted, it is possible to prevent a trailing end portion of the preceding printing paper P and a leading end portion of the following printing paper P from overlapping on each other. In this connection, whether or not it is in a state, in which the trailing end portion of the preceding printing paper P has left the rear paper feeding roller 27 and a transporting of the following printing paper P by the rear paper feeding roller 27 can start, can be recognized by the number of times of intermittent transporting of printing paper P. When the trailing end portion of the preceding printing paper P has left the rear paper feeding roller 27 and a transporting of the following printing paper P by the rear paper feeding roller 27 has started, start correcting control may be conducted.

In the present embodiment, when the trailing end portion of the preceding printing paper P has left the rear paper feeding roller 27 and a transporting of the following printing paper P by the rear paper feeding roller 27 has started, the rear paper feeding roller 27 and the retard roller 28 somewhat slip on the following printing paper P. Therefore, as shown in FIG. 11(B), predetermined gap C is formed between the trailing end of the preceding printing paper P and the leading end of the following printing paper P. This gap C is, for example, 1 mm to 5 mm.

After that, when the following printing paper P is transported by both PF drive roller 4 and the rear paper feeding roller 27 as shown in FIG. 11(C), that is, when the leading end of printing paper P reaches a position where PF drive roller 4 is arranged, synchronous transporting control is conducted and at the same time start correcting control is conducted again. Whether or not it is in a state, in which the following printing paper P is being transported by both PF drive roller 4 and the rear paper feeding roller 27, can be recognized by whether or not the paper detecting device 9 detects the leading end of printing paper P as described above.

After that, as shown in FIG. 11(C), the following printing paper P is intermittently transported by PF drive roller 4 and the rear paper feeding roller 27. When the leading end of the following printing paper P reaches a position where the ejecting drive roller 6 is arranged, the following printing paper P is intermittently transported by PF drive roller 4, the ejecting drive roller 6 and the rear paper feeding roller 27. On the other hand, the preceding printing paper P is intermittently transported by the ejecting drive roller 6 and transported from the printer 1. In these intermittent transporting actions, PF drive roller 4 and the ejecting drive roller 6 are subjected to rotation control according to PF speed profile F1, and the rear paper feeding roller 27 is subjected to rotation control according to paper feeding speed profile F2. That is, synchronous transporting control is conducted. Start correcting control is conducted. Therefore, printing paper P, which is being transported, is loosened between PF drive roller 4 and the rear paper feeding roller 27. Printing paper P is stretched at the time of stoppage. Printing is conducted on printing paper P at the time of stoppage of printing paper P.

As described above, at the time of continuous printing in the draft printing mode, first, PF drive roller 4 and the rear paper feeding roller 27, which are rotated at the substantially same circumferential speed, cooperate with each other so that printing paper P, which has been fed inside the printer 1, that is, printing paper P, the leading end portion of which has been transported to a position where PF drive roller 4 is arranged, can be transported. After that, when the leading end portion of printing paper P reaches a position where the ejecting drive roller 6 is arranged, in addition to PF drive roller 4 and the rear paper feeding roller 27, the ejecting drive roller cooperates so as to transport printing paper P inside the printer 1. After that, when the trailing end of printing paper P has left the rear paper feeding roller 27, PF drive roller 4 and the ejecting drive roller 6 cooperate with each other, so that printing paper P inside the printer 1 can be transported.

Successively, explanations will be made into control conducted when the last sheet of printing paper P is transported at the time of continuous printing.

As shown in FIG. 12(A), when a leading end of the last sheet of printing paper P is transported to a position where PF drive roller 4 and PF driven roller 5 are arranged at the time of continuous printing, as shown in FIGS. 3(B) and 12(B), a lower end portion of the rear paper feeding hopper 26 leaves the rear paper feeding roller 27 and the retard roller 28 also leaves the rear paper feeding roller 27. ASF motor 31 is stopped and the rear paper feeding roller 27 is also stopped. After that, the last sheet of printing paper P is intermittently transported by PF drive roller 4 and the ejecting drive roller 6. In this way, the last sheet of printing paper P is transported by separate transporting control.

Specifically, only PF motor 14 is intermittently driven and printing paper P is intermittently transported by PF drive roller 4 and the ejecting drive roller 6. At the same time, ink drops are jetted out from the printing head 2, so that printing is conducted on printing paper P. After the completion of printing on printing paper P, PF motor 14 is continuously driven. Therefore, printing paper P is transported outside the printer 1.

### (Control Flow of Transporting Control of Printing Paper)

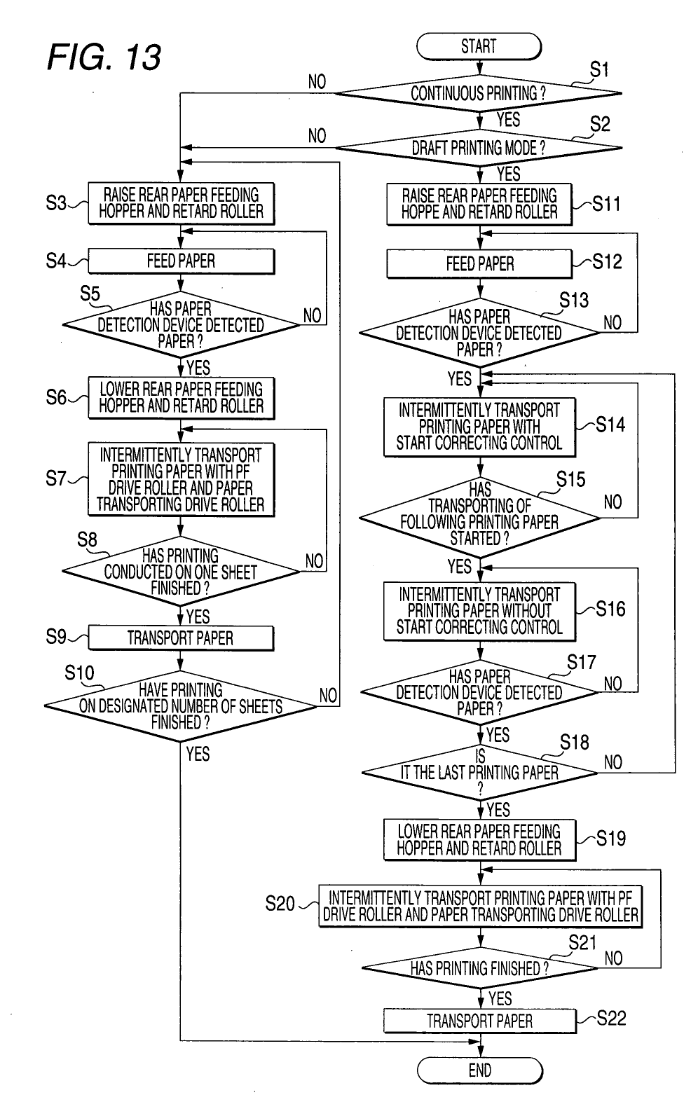

FIG. 13 is a flow chart showing a procedure of transporting control of printing paper P.

Referring to the flow chart shown in FIG. 13, the procedure of transporting control of printing paper P, which has been explained before referring to FIGS. 10 to 12, will be explained.

When a printing command is inputted from the control command portion 59 into the control portion 50, the control portion 50 starts printing control of printing paper P. That is, the control portion 50 starts transporting control of printing paper P. In the transporting control, first, it is judged whether or not printing conducted on printing paper P is continuous printing (step S1). In the case of continuous printing, it is judged whether or not the continuous printing is conducted in the draft printing mode (step S2).

In a case where it is judged in step S2 that the continuous printing is not in the draft printing mode but in the normal printing mode or in a case where it is judged in step S1 that printing is not continuous printing but one sheet printing, separate transporting control is conducted. Specifically, first, as shown in FIG. 3(A), a lower end portion of the rear paper feeding hopper 26 and the retard roller 28 are raised up (step S3), and printing paper P is transported from the rear paper feeding hopper 26 by the rear paper feeding roller 27, that is, printing paper P is fed (step S4). Then it is judged whether or not the paper detection device 9 has detected a leading end of printing paper P (step S5). In a case where the paper detection device 9 has not detected the leading end of printing paper P, the program is returned to step S4. In a case where the paper detection device 9 has detected the leading end of printing paper P, as shown in FIG. 3(B), the lower end portion of the rear paper feeding hopper 26 and the retard roller 28 are lowered (step S6).

After that, printing paper P is intermittently transported by PF drive roller 4 and the ejecting drive roller 6 (step S7). In step S7, the rear paper feeding roller 27 is stopped. At the time of stoppage of intermittent transporting, according to the necessity, printing is conducted on printing paper P with the printing head 2. After that, it is judged whether or not printing on the thus fed one sheet of printing paper P has been finished (step S8). In a case where printing on the thus fed one sheet of printing paper P has not been finished, the program is returned to step S7. In a case where printing on the thus fed one sheet of printing paper P has been finished, printing paper P is transported with the ejecting drive roller 6 (step S9). After the transporting of printing paper P or at the time of transporting printing paper P, it is judged whether or not printing on the designated number of sheets of printing paper P, which has been inputted from the control command portion 59, is finished (step 5b). In a case where printing on the designated number of sheets of printing paper P has been finished, transporting control conducted on printing paper P is finished, that is, printing control is finished. In a case where printing on the designated number of sheets of printing paper P has not been finished, the program is returned to step S3. In this connection, in the case of one sheet printing in step S1, step S10 is omitted.

In a case where it is judged in step S2 that it is a draft printing mode, as shown in FIG. 3(A), the lower end portion of the rear paper feeding hopper 26 and the retard drum 28 are raised up (step S11) and printing paper P is transported and fed from the rear paper feeding hopper 26 by the rear paper feeding roller 27 (step S12). In step S12, the rear paper feeding roller 27 is subjected to rotation control according to the paper feeding speed profile F2. In step S12, simultaneously when the rear paper feeding roller 27 is set in motion, PF drive roller 4 and the ejecting drive roller 6 are also set in motion, and PF drive roller 4 and the ejecting drive roller 6 are subjected to rotation control according to PF speed profile F1. That is, synchronous transporting control is conducted in step S12. In this connection, synchronous transporting control may not be conducted in step S12.

Then, it is judged whether or not the paper detection device 9 has detected a leading end of printing paper P (step S13). In a case where the paper detection device 9 has not detected the leading end of printing paper P, the program is returned to step S12. In a case where the paper detection device 9 has detected the leading end of printing paper P, printing paper P is intermittently transported by the PF drive roller 4 and/or the ejecting drive roller 6, which is subjected to rotation control according to PF speed profile F1, and by the rear paper feeding roller 27 which is subjected to rotation control according to the paper feeding speed profile F2 (step S14). That is, in step S14, synchronous transporting control is conducted. In step S14, start correcting control is also conducted. At the time of stoppage of the intermittent transporting action, according to the necessity, printing is conducted on printing paper P with the printing head 2.

After that, as shown in FIG. 11(A), the trailing end of the preceding printing paper P leaves the rear paper feeding roller 27 and it is judged whether or not the rear paper feeding roller 27 starts transporting the following printing paper P (step S15). In a case where the rear paper feeding roller 27 does not start transporting the following printing paper P, the program is returned to step S14. In a case where the rear paper feeding roller 27 starts transporting the following printing paper P, printing paper P is intermittently transported by PF drive roller 4 and the ejecting drive roller 6 which are subjected to rotation control according to PF speed profile F1 and by the rear paper feeding roller 27 which is subjected to rotation control according to paper feeding speed profile F2 (step S16). That is, in step S16, synchronous transporting control is conducted. In step S16, start correcting control is not conducted. In this connection, start correcting control may be conducted in this step S16.

It is judged whether or not the paper detection device 9 has detected a leading end of printing paper P (step S17). In a case where the paper detection device 9 has not detected the leading end of printing paper P, the program is returned to step S16. In a case where the paper detection device 9 has detected the leading end of printing paper P, it is judged whether or not the following printing paper P, which has been fed, is the last sheet of printing paper P in continuous printing (step S18). In a case where the following printing paper P is not the last sheet of printing paper P, the program is returned to step S14. In a case where the following printing paper P is the last sheet of printing paper P, the lower end portion of the rear paper feeding hopper 26 and the retard roller 28 are lowered in the same manner as that of step S6 (step S19).

After that, in the same manner as that of step S7, printing paper P is intermittently transported by PF drive roller 4 and the ejecting drive roller 6 (Step S20). In step S20, the rear paper feeding roller 27 is stopped. That is, the last sheet of printing paper P is transported by separate transporting control. At the time of stoppage of the intermittent transporting action, according to the necessity, printing is conducted on printing paper with the printing head 2. After that, it is judged whether or not printing conducted on the last sheet of printing paper P has been finished (step S21). In a case where printing on the last sheet of printing paper P has not been finished, the program is returned to step S20. In a case where printing on the last sheet of printing paper P has been finished, the printing paper P is transported by the ejecting drive roller 6 (step S22) and transporting control of printing paper P is finished.

In the present embodiment, step S2 is a judgment step for judging whether printing is conducted on printing paper P by the draft printing mode or printing is conducted on printing paper P by the normal printing mode. Steps S3 to S9 are the second transporting printing step for conducting transporting and printing on printing paper P when it is judged to be the normal printing mode in step S2 which is a judgment step. Steps S11 to S22 are the first transporting printing step for conducting transporting and printing on printing paper P when it is judged in step S2 that it is the draft printing mode.

### ADVANTAGEOUS EFFECTS OF THE EMBODIMENT

As explained above, in the draft printing mode of the present embodiment, at the time of continuous printing, PF drive roller 4 and the rear paper feeding roller 27, which are rotated at the substantially same circumferential speed, cooperate with each other so as to conduct synchronous transporting control for transporting printing paper P. That is, in the draft printing mode, while PF drive roller 4 and the rear paper feeding roller 27 are being synchronized with each other, printing paper P, which has been fed from the rear paper feeding cassette 26 inside the printer 1, is transported. Therefore, printing paper P can be fed without causing any problem in the transporting action and the printing action of printing paper P. That is, in the present embodiment, the printing action, the transporting action and the feeding action can be conducted as a series of actions. As a result, at the time of continuous printing conducted in the draft printing mode, throughput can be more enhanced.

In the draft printing mode of this embodiment, while PF drive roller 4 and the rear paper feeding roller 27 are being synchronized with each other, printing paper P, which has been fed from the rear paper feeding cassette 26 inside the printer 1, is transported. Therefore, printing paper P can be transported in an appropriate state between PF drive roller 4 and the rear paper feeding roller 27. As a result, it is possible to suppress the generation of noise which is generated from printing paper P when tension given to printing paper P between the rollers is changed.

In the normal printing mode of the present embodiment, separate transporting control is conducted in such a manner that at the time of continuous printing, after printing paper P has been fed from the rear paper feeding cassette 26 to the inside of the printer 1, the rear paper feeding roller 27 is stopped and printing paper P, which has been fed from the rear paper feeding cassette 26 to the inside of the printer 1, is transported by PF drive roller 4. Therefore, in the normal printing mode, the transporting action of transporting printing paper P and the printing action can be separate from the feeding action of printing paper P. Accordingly, printing action can be performed without being affected by the feeding action. For example, in the normal printing mode, “cue of printing paper P” which is not conducted in synchronous transporting control, can be performed. In the normal printing mode, PF motor 14 and ASF motor 31 are subjected to PID control according to individual target speed tables which are independently set. Therefore, a transporting speed and an amount of transporting of printing paper P at the time of intermittent transporting conducted by PF drive roller 4 and the ejecting drive roller 6 can be set irrespective of the feeding action. As a result, the printing precision can be enhanced.

In the present embodiment, even in the draft printing mode, the last sheet of printing paper P at the time of continuous printing is subjected to separate transporting control. Therefore, even in a case where sheets of printing paper P, the number of which is not less than a designated number of continuous printing, are set in the rear paper feeding hopper 26, it is possible to prevent the following printing paper P from entering the inside of the printer 1.

### THE OTHER EMBODIMENTS

The above embodiment is an example of the preferred embodiment of the present invention. However, it should be noted that the present invention is not limited to the above specific embodiment. Variations can be made without departing from the spirit and the scope of claim of the present invention.

In the embodiment described above, PF target speed table T1 and ASF target speed table T2 are set so that PF speed profile F1, which has been made according to PF target speed table T1, and paper feeding speed profile F2, which has been made according to ASF target speed table T2, can be substantially the same with each other, and start correcting control is conducted when one sheet of printing paper P is transported by both PF drive roller 4 and the rear paper feeding roller 27 in the draft printing mode. Therefore, at the time of transporting, printing paper P is loosened between PF drive roller 4 and the rear paper feeding roller 27. However, at the time of stoppage, printing paper P is stretched. Except for that, the following constitution may be employed. For example, when ASF target speed table T2 is a little corrected and start correcting control is conducted, printing paper P transported by PF drive roller 4 and the rear paper feeding roller 27 may be always loosened between PF drive roller 4 and the rear paper feeding roller 27.

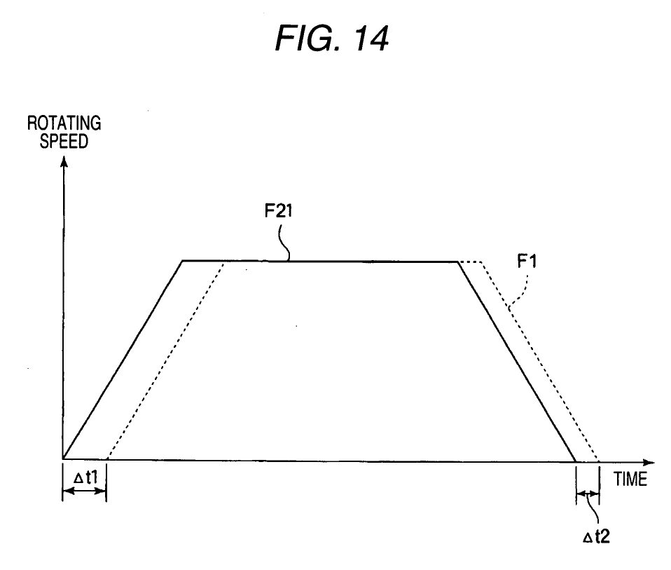

For example, as shown in FIG. 14, ASF target speed table T2 may be set on the basis of PF target speed table T1 so that the constant speed region of paper feeding speed profile F21 can be a little longer than the constant speed region of PF speed profile F1. That is, when start correcting control is conducted, PF motor 14 is started being delayed from ASF motor 31 by Δt1. However, on the basis of PF target speed table T1, ASF target speed table T2 may be set so that PF motor 14 can be stopped being delayed from ASF motor 31 by Δt2 (Δt1>Δt2). In other words, on the basis of PF target speed table T1, ASF target speed table T2 may be set so that the rear paper feeding roller 27 can transport more sheets of printing paper P than PF drive roller 4. At the time of start correcting control, when printing paper P, which is transported by PF drive roller 4 and the rear paper feeding roller 27, is always loosened between PF drive roller 4 and the rear paper feeding roller 27, the generation of noise of printing paper P can be prevented at the time of transporting.

The above embodiment is an example in which printing paper P is fed from the rear side to the inside of the printer 1. In this example, the method of transporting control of transporting printing paper P in the printer 1 is explained. That is, in the above embodiment, at the time of continuous printing in the draft printing mode, according to PF target speed table T1 corresponding to PF speed profile F1, PF motor 14 is controlled. According to ASF target speed table T2 corresponding to paper feeding speed profile F2, ASF motor 31 is controlled. Except for that, the following method may be employed. For example, according to PF target speed table T1 corresponding to PF speed profile F1, PF motor 14 is controlled. According to ASF target speed table corresponding to the substantially same speed profile as PF speed profile F1 in which a relation between the rotating time of the front paper feeding roller 21 and the target rotating speed or a relation between the rotating distance of the front paper feeding roller 21 and the target rotating speed is shown, ASF motor 31 may be controlled. That is, transporting control of transporting printing paper P of the present embodiment can be applied to a case in which printing paper P is fed inside the printer 1. In this case, it is preferable that a detection device having the same function as that of the paper detecting device 9 is arranged at a position close to the front paper feeding roller 21. In this case, the front paper feeding roller 21 is a feeding roller for feeding printing paper P into the inside of the printer 1. The front paper feeding cassette 20 is a medium setting portion in which printing paper P is set before printing.

Further, in the above embodiment, at the time of continuous printing conducted in the draft printing mode, when a leading end of the first sheet of printing paper P is transported to a position where PF drive roller 4 and PF driven roller 5 are arranged, synchronous transporting control is also conducted. Except for that, for example, when the leading end of the first sheet of printing paper P is transported to a position where PF drive roller 4 and PF driven roller 5 are arranged, in the same manner as that of the conventional example, only ASF motor 31 may be driven and only the rear paper feeding roller 27 may be rotated.

Further, in the above embodiment, PF motor 14 and ASF motor 31 are subjected to PID control. Except for that, for example, PF motor 14 and ASF motor 31 may be controlled by feedback control such as PI control or proportional control. The constitution of the present embodiment can be applied to ink jet printers and various devices having a paper feeding mechanism such as a laser beam printer.

What is claimed is:

1. A printer operable to print on a printing medium, comprising:
a transporting roller operable to transport the printing medium fed from a medium setting portion on which the printing medium is set;
a feeding roller operable to feed the printing medium from the medium setting portion; and
a controller operable to execute at least a synchronous transporting control of the printing medium in a first printing mode and execute at least a separate transporting control of the printing medium in a second printing mode when continuously printing on plural sheets of the printing medium, wherein:
in the synchronous transporting control, the transporting roller and the feeding roller which rotate at the same circumferential speed transport the printing medium fed from the medium setting portion in cooperation with each other; and
in the separate transporting control, the feeding roller is stopped after feeding the printing medium from the medium setting portion and the transporting roller transports the printing medium fed from the medium setting portion while the feeding roller is stopped.

2. The printer as set forth in claim 1, wherein the controller executes the separate transporting control on the last one of the plural sheets of the printing medium in the first printing mode.

3. A method for controlling a printer operable to print on a printing medium, comprising:
judging whether the recording medium is printed in a first printing control in which at least a synchronous transporting control of the printing medium is executed or in a second printing control in which at least a separate transporting control of the printing medium is executed when continuously printing on plural sheets of the printing medium;
when it is judged that the recording medium is printed in the first printing control, transporting the printing medium and printing on the printing medium in the first printing control; and
when it is judged that the recording medium is printed in the second printing control, transporting the printing medium and printing on the printing medium in the second printing control, wherein:
in the synchronous transporting control, a transporting roller operable to transport the printing medium fed from a medium setting portion on which the printing medium is set and a feeding roller operable to feed the printing medium from the medium setting portion, which rotate at the same circumferential speed transport the printing medium fed from the medium setting portion in cooperation with each other; and
in the separate transporting control, the feeding roller is stopped after feeding the printing medium from the medium setting portion and the transporting roller transports the printing medium fed from the medium setting portion while the feeding roller is stopped.

4. A method for controlling a printer operable to print on a printing medium;
rotating a feeding roller at a first circumferential speed, thereby feeding a first printing medium;
rotating a transporting roller at the first circumferential speed, thereby transporting the fed first printing medium in cooperation with the feeding roller; and
printing on the transported first printing medium.

5. The method as set forth in claim 4, further comprising rotating a ejecting roller at the first circumferential speed, thereby ejecting the printed first printing medium in cooperation with the transporting roller.

6. The method as set forth in claim 4, wherein the transporting roller starts to rotate at a time when the feeding roller starts to rotate.

7. The method as set forth in claim 4, wherein the transporting roller starts to rotate at a time when a predetermined time period is elapsed after the feeding roller starts to rotate.

8. The method as set forth in claim 4, further comprising:
rotating the feeding roller, thereby feeding a second printing medium toward the transporting roller;
stopping the feeding roller after the fed second printing medium comes in contact with the transporting roller;
rotating the transporting roller, thereby transporting the fed second printing medium; and
printing on the transported second printing medium.

9. The method as set forth in claim 8, further comprising:
separating the feeding roller from the second printing medium after stopping the feeding roller.
